(19) United States
(12) Patent Application Publication
(10) Pub. No.: US 2007/0108316 A1
(43) Pub. Date: May 17, 2007

(54) Blade-curtain outlet water structure of cleanout handle

(76) Inventor: Chiu-Chih Chung, Chunghua Hsien (TW)

Correspondence Address: TROXELL LAW OFFICE PLLC;SUITE 1404, 5205 LEESBURG PIKE, FALLS CHURCH, VA, 22041, US

(21) Appl. No.: 11/274,159

(22) Filed: Nov. 16, 2005

(51) Int. Cl. B05B 9/08

(52) U.S. Cl. 239/530; 239/583; 239/597; 239/601

(57) ABSTRACT

An improved blade-curtain outlet water structure of cleanout handle which is comprised by main body of cleanout handle, adapter connector, water guide connector, outlet connector and sheath; Water inlet and outlet screw are respectively fixed at end of main penstock of cleanout handle, close trough seat of outlet screw is to control outflow and stop with handle; its features are as follows: adapter connector is to lock up outlet screw of main body with screw thread end, and then couple sheath with outer stop edge, the end-setting screw of internal trough locks up water guide connector, its internal part is set as layered penstock, and then set several through holes in the shrunk section of another end of penstock and provide screw thread section for lock-up; one end is set as thin trough-shaped water outlet, which is to lock up screw thread section of water guide connector with screw thread trough at another end; therefore, this structure combinations can provide hydraulic pressure and collective water supply so as to produce blade-curtain outlet water, which is convenient to flush in high hydraulic pressure and also flush completely in large area.

### BACKGROUND OF THE INVENTION

1) Field of the Invention

This invention relates to an improved blade-curtain outlet water structure of cleanout handle, which controls outflow and stop of water with handle, water outlet is structured as thin trough with layer shrinking of internal penstock and outlet adapter, therefore, it may flow out blade-curtain water owing to high hydraulic pressure and collective water supply mode.

2) Description of the Prior art

According to the current invention, “cleanout handle” controls outflow and stop of water by pressing handle, or control the outlet capability of cleanout handle with rotating method, so, water entering into internal penstock of cleanout handle can be controlled by control device, water supply may not be blocked and flow out through water outlet of outlet adapter accordingly; however, because there are not big differences in its pipe diameter, so, flow pressure formed by internal penstock of the common cleanout handle are equally, thereby, the strength of water bundle produced may not be stable due to such instable hydraulic pressure, so that its flush capability is not good as expected and also not easy to control, therefore, it cannot provide effective application efficiency as required; in addition, because its water outlet is mostly structured with round diameter or scale-out cone so that outflow can only be formed as point-blank or radial water bundle due to the round diameter, its outflow area is limited, therefore, such structure is necessary to get improved.

### SUMMARY OF THE INVENTION

I. Problem to Solve

1. Internal penstock of common cleanout handle is made of pipe with fixed diameter, so, there is no big difference between the formed flow pressure and water inlet pressure, therefore, outflow is very weak or instable due to the unequal water inlet pressure, so that it cannot provide best flush and control.

2. The water outlet in round diameter or scale-out cone may produce point-blank or radial water bundle that may not only limit outlet area of its structure, moreover, its application may not be desirable because it cannot increase hydraulic pressure.

II. Solution

A. This invention is to apply layer design of penstock (aperture changes from big to small) and side through hole to change output direction of penstock (don't directly guide), so that water flow can be pressed in two sections in the penstock.

B. The stage-pressing water flow can thoroughly flush out impurities and dirt in penstock, so that water flow may not be blocked.

C. The water flow pressed in two stages are then squeezed via thin trough-shaped water outlet, so that water flow may be further pressed, moreover, the thin trough water outlet can provide water curtain, therefore, it can provide strong and large area of flush.

### BRIEF DESCRIPTION OF THE DRAWINGS

FIG. 1 is the exploded view of this invention

FIG. 2 is the exploded combination drawing of this invention.

FIG. 3 is the combination section drawing of this invention

### DETAILED DESCRIPTION OF THE PREFERRED EMBODIMENTS

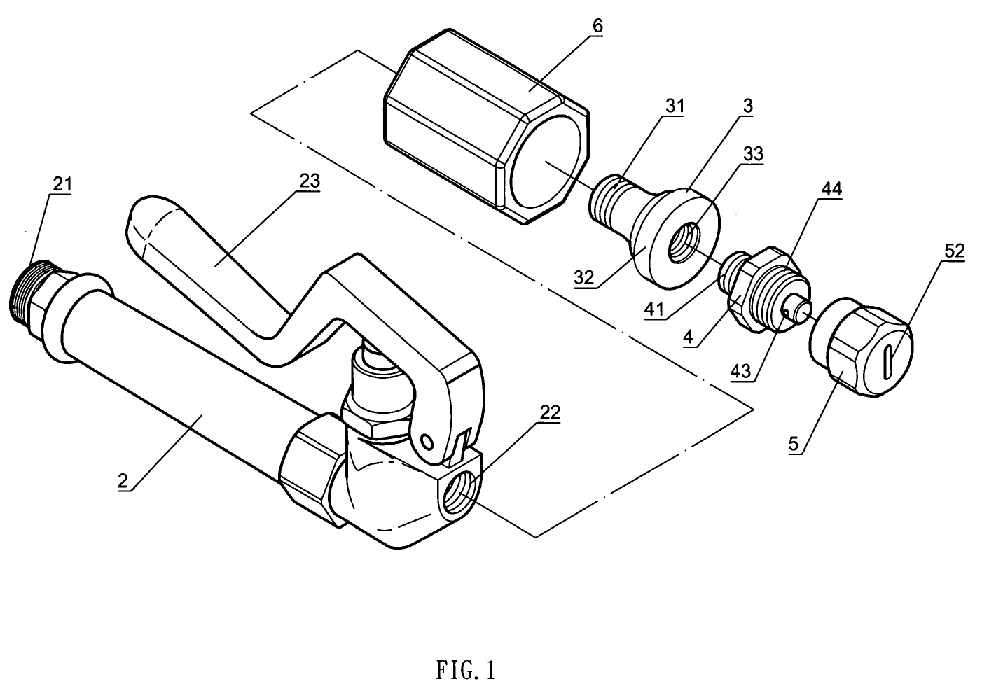

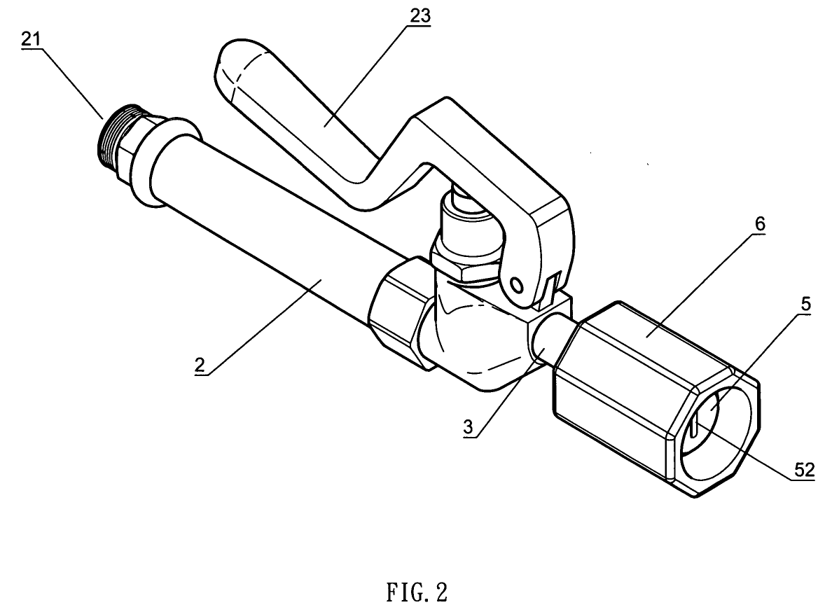

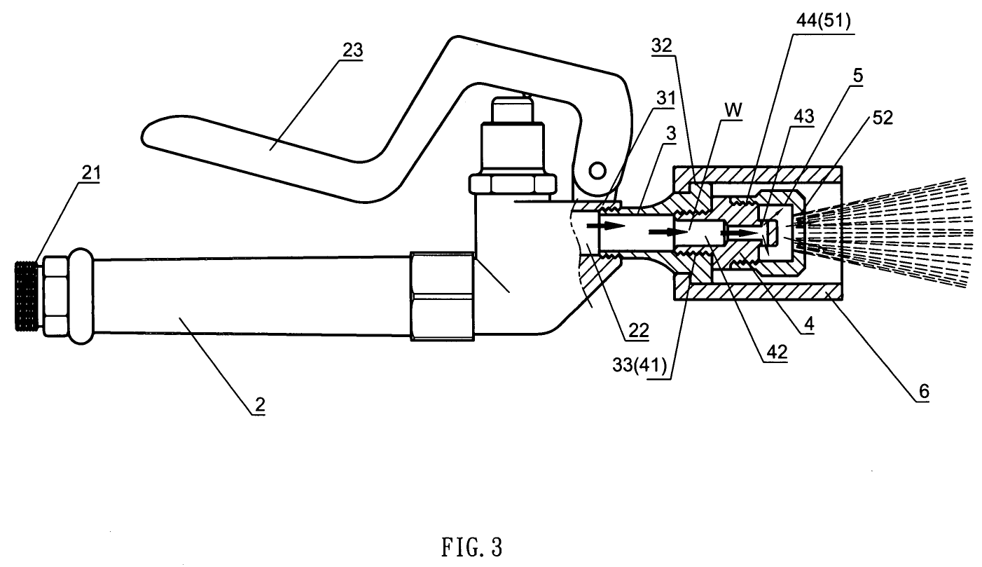

The operation and application examples are herein specially provided in the following, please first refer to FIG. 1, FIG. 2 and FIG. 3.:

This invention is composed of main body 2 of cleanout handle, adapter connector 3, water guide connector 4, outlet adapter 5 and sheath 6; wherein

Main body of cleanout handle is 2, water inlet 21 to inlet water and outlet screw 22 to provide water are respectively fixed at end of main penstock 2, close trough seat of outlet screw 22 controls outflow and stop of water by handle 23.

Adapter connector 3 is to lock up outlet screw 22 of main body 2 with screw thread end 31, and then couple sheath 6 with outer stop edge 32, then make screw 33 in proper depth in another end of internal slot; water guide connector 4 is locked up with thread end 41 and screw 33 of adapter connector 3, its internal part is set as layered penstock 42, and then set several through holes 43 in the shrunk section of another end of penstock 42 and screw thread section 44 for lock-up at its outside;

Outlet adapter 5 is to lock up screw thread section 44 of water guide connector 4 with end screw thread and set thin trough-shaped outlet 51 in another side end.

This structure may provide high pressure flush, press handle 23 to open water-controlling device of main body 2, at this time, water flow W may flow through main body 2 without any block, then enter into penstock 42 of water guide connector 4 from internal trough of adapter connector 3, penstock 42 is shrunk so as to first press water flow W, when water flow W turn to through hole 43 at side and flow out, water flow W may be secondly pressed by the turning and shrinking of through hole 43, so, the secondly pressed water flow W is outputted collectively from thin trough-shaped water outlet 51, therefore, the outlet water may be in blade-curtain owing to the pressure and collective water supply, which is convenient to flush in high hydraulic pressure and also flush completely in large area.(Please refer to FIG. 3 for detail).

To sum up all above descriptions, the cleanout handle invented by this invention indeed can produce large area of blade-curtain outlet water, the multi-section pressure-increasing capability strengthen the flush effects, therefore, this invention has been in conformity with the requirement of new patent.

What is claimed is:

1. An improved blade-curtain outlet water structure of cleanout handle which is comprised by main body of cleanout handle, adapter connector, water guide connector, outlet connector and sheath; Water inlet and outlet screw are respectively fixed at end of main penstock of cleanout handle, close trough seat of outlet screw is to control outflow and stop with handle; its features are as follows: adapter connector is to lock up outlet screw of main body with screw thread end, and then couple sheath with outer stop edge, then end-setting screw of internal trough locks up water guide connector, its internal part is set as layered penstock, and then set several through holes in the shrunk section of another end of penstock and provide screw thread section for lock-up; one end is set as thin trough-shaped water outlet, which is to lock up screw thread section of water guide connector with screw thread trough at another end; therefore, this structure combinations can provide hydraulic pressure and collective water supply so as to produce blade-curtain outlet water, which is convenient to flush in high hydraulic pressure and also flush completely in large area.
